(19) United States
(12) Patent Application Publication
(10) Pub. No.: US 2024/0129452 A1
(43) Pub. Date: Apr. 18, 2024

(54) METHOD AND DEVICE FOR RECOGNISING IMPAIRMENTS IN THE OPTICAL PATH OF A STEREO CAMERA

(71) Applicant: MERCEDES-BENZ GROUP AG, Stuttgart (DE)

(72) Inventors: Stephan ZINKLER, Stuttgart (DE); Martin HÜMMER, Sindelfingen (DE)

(21) Appl. No.: 18/275,828

(22) PCT Filed: Dec. 1, 2021
(86) PCT No.: PCT/EP2021/083795

§ 371 Date: Aug. 4, 2023

(30) Foreign Application Priority Data
Feb. 5, 2021 (DE) 10 2021 000 600.3

(51) Int. Cl. H04N 17/00; G06V 20/56; G06V 20/58; H04N 13/271

(52) U.S. Cl. CPC H04N 17/002; G06V 20/58; G06V 20/588; H04N 13/271

(57) ABSTRACT

A method for recognizing impairments in the optical path of a stereo camera involve generating a depth map of a recorded environment using image data recorded by the stereo camera. It is checked whether gaps without depth values are present in the depth map. If gaps are present in the depth map, it is determined that impairments are present in the optical path of the stereo camera.

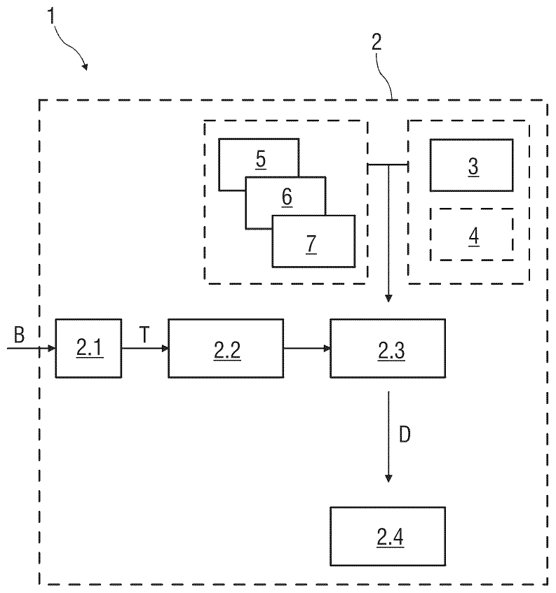

### BACKGROUND AND SUMMARY OF THE INVENTION

Exemplary embodiments of the invention relate to a method for recognizing impairments in the optical path of a stereo camera, to a device for recognizing impairments in the optical path of a stereo camera, and to a vehicle.

DE 10 2016 216 118 A1 discloses a smudge recognition method in an object recognition device and an object recognition device that is arranged in a vehicle and that uses recorded images of a stereo camera. The stereo camera comprises two cameras, each of which records an exterior environment of the vehicle from the vehicle interior through a region of a window pane that is wiped by a windscreen wiper. The object recognition device has a light source detector that can recognize a light source in a recorded image that has been recorded by one of the two stereo cameras. The object recognition device further has an edge detector that can recognize an edge extending in a direction intersecting with a wiping direction of the windscreen wiper in the image recorded by one of the two cameras. The object recognition device further has a determiner that can determine that the windscreen has a smudge if the edge extending from the light source in the intersection direction is recognized continuously for a specific duration on the basis of a recognition result of the light source detector and a recognition result of the edge detector.

Exemplary embodiments of the invention are directed to an improved method and an improved device for recognizing impairments in the optical path of a stereo camera in relation to the prior art, as well as to a new kind of vehicle.

In the method for recognizing impairments in the optical path of a stereo camera, a depth map, also described as a disparity image or disparity map, of a recorded environment is generated according to the invention using image data recorded by means of the stereo camera. It is further checked whether gaps without depth values are present in the depth map. If gaps are present in the depth map, it is determined that impairments are present in the optical path of the stereo camera.

The optical path of a stereo camera can be impaired by ageing and environmental influences. For example, blurring resulting from ageing processes, blockages resulting from precipitation, dirt, etc., glare resulting from sunlight can arise. Quick and robust recognition of such impairments, also described as degradation, in the optical path of a stereo camera is very important for reliable operation of functions that use image data recorded by means of the stereo camera.

Unlike methods known from the prior art, the method herein enables impairments in the optical path of a stereo camera to be recognized even without movement being present in the image data recorded by the stereo camera. This means that the method enables the recognition of impairments even in the case of a standstill of the stereo camera and in static scenarios. This method for this recognition can be used as a so-called standalone solution or to improve and/or perform a plausibility check of pre-existing algorithms. The method here forms further recognition input for increasing robustness and recognition speed.

In a possible embodiment of the method, objects are recognized in the depth map and a plausibility check of depth information of the depth map is carried out using a comparison of the recognized objects with object information stored in a digital map. For example, in this context, in a further preferred embodiment of the method, implausible depth information is interpreted as confirmation of an impairment in the optical path of the stereo camera. An error rate in recognizing the impairments in the optical path can thus be reduced and reliability and robustness of the method can be further increased.

In a further possible embodiment of the method, implausible depth information is also interpreted as confirmation of an impairment in the optical path of the stereo camera if there are no gaps present in the depth map. Impairments in the optical path that are present on both camera units and thus do not lead to gaps in the depth map can thus also be recognized.

In a further possible embodiment of the method, the image data is recorded by means of the stereo camera while the stereo camera is at a standstill relative to the recorded environment.

In a further possible embodiment of the method, lane recognition, number plate recognition, recognition of mobile environment objects, and/or recognition of immobile environment objects is/are carried out in the object recognition. This enables a plurality of objects present in the environment and in the digital map to be compared and thus leads the plausibility check to be further improved.

The device for recognizing impairments in the optical path of a stereo camera is characterized according to the invention by a processing device that is designed to generate a depth map of a recorded environment using image data recorded by means of the stereo camera, check whether gaps without depth values are present in the depth map and, if gaps are present in the depth map, determine that impairments are present in the optical path of the stereo camera.

Unlike devices known from the prior art, the device enables impairments in the optical path of a stereo camera to be recognized even without movement being present in the image data recorded by the stereo camera. This means that the device enables the recognition of impairments even in the case of a standstill of the stereo camera and in static scenarios. The device for this recognition can be used as a so-called standalone solution or to improve and/or perform a plausibility check of pre-existing algorithms. The device here generates further recognition input for increasing robustness and recognition speed.

The vehicle according to the invention comprises a previously specified device. Reliability of an operation of vehicle functions, for example driver assistance functions that use image data recorded by means of the stereo camera, can thus be significantly increased. Traffic safety can thus be increased.

In a possible embodiment of the vehicle, the vehicle is designed to be driven in an automated manner, in particular a highly automated or autonomous manner. The device here enables a particularly reliable automated driving operation, as driving functions have increased reliability and increased availability due to the use of the device. Traffic safety can thus also be increased, and vehicle drivers can be better supported in the driving task.

### BRIEF DESCRIPTION OF THE SOLE DRAWING FIGURE

Exemplary embodiments of the invention are explained in more detail in the following with reference to the sole FIGURE, which schematically shows a device for recognizing impairments in the optical path of a stereo camera.

### DETAILED DESCRIPTION

In the sole FIGURE, a possible exemplary embodiment of a device 1 for recognizing impairments D in the optical path of a stereo camera is schematically depicted. The device 1 comprises a processing device 2 for this recognition.

For example, the device 1 is a component of a vehicle (not depicted in more detail). For example, the vehicle is designed to be driven in an automated manner, in particular a highly automated or autonomous manner, wherein image data B recorded by means of the stereo camera is used to carry out the automated driving operation. A reliable operation of the stereo camera is required for this purpose.

An optical path of a stereo camera can be impaired by ageing and environmental influences. For example, blurring resulting from ageing processes, blockages resulting from precipitation, dirt, etc., glare resulting from sunlight can arise. Quick and robust recognition of such impairments D, also described as degradation, in the optical path of a stereo camera is very important for reliable operation of the stereo camera and of functions that use image data B recorded by means of the stereo camera.

If the optical path of the stereo camera is not impaired, then a detailed and gapless depth map of an environment of the stereo camera, for example of a road and its environment, can be created in stereoscopic processing of image data recorded by means of the stereo camera B. Impairments D in the optical path of the stereo camera are directly reflected in the depth map in the form of gaps without depth values and thus indicate such an impairment D.

For this reason, to recognize impairments D in the optical path of the stereo camera, a depth map T, also described as a disparity image or disparity map, of a recorded environment is generated by means of the processing device 2 in a first module 2.1 using image data B recorded by means of the stereo camera. The recording of the image data B by means of the stereo camera can also be carried out during a standstill of the stereo camera relative to the recorded environment, i.e., during a standstill of the vehicle.

In a second module 2.2, it is then checked whether gaps without depth values are present in the depth map T.

In a further module 2.3 of the processing device 2, potential candidates for an impairment D in the optical path of the stereo camera are determined. If gaps are present in the depth map T, it is determined here that impairments D are present in the optical path of the stereo camera.

In a possible embodiment, objects are additionally recognized in the depth map T and a plausibility check of depth information of the depth map T is carried out using a comparison of the recognized objects with object information stored in a digital map 3 and/or by means of object information recorded by a further sensor 4.

The object recognition in the depth map T is, for example, camera-based and, for example, comprises recognition 5 of mobile and/or immobile environment objects, lane recognition 6 and number plate recognition 7.

If, as a result of the plausibility check, implausible depth information is present, this implausible depth information is interpreted as confirmation of an impairment D in the optical path of the stereo camera.

Implausible depth information is also interpreted as confirmation of an impairment D in the optical path of the stereo camera if there are no gaps present in the depth map T. This is the case, for example, if impairments D are present on both camera units of the stereo camera.

If an impairment D has been recorded in the optical path of the stereo camera, signaling occurs by means of a corresponding module 2.4 of the processing device 2, such that the impairment D can be automatically or manually removed.

In the following, two exemplary uses with an impairment D in the optical path of a stereo camera are described.

In a first application example, one of two optical camera lenses of a stereo camera is degraded. If so-called vertical light blades arise due to reflections caused by sunlight on the camera lens, these light blades lead to vertical gaps in the depth map T. Precipitation on the camera lens leads to extensive gaps or implausible stereo information. Dirt leads to individual gaps in the depth map. Overexposure or exposure, which result for example from a low sun, lead to similar effects as precipitation. When the gaps, their shape and arrangement are recognized, a type of impairment D can thus be determined.

In a second application example, both camera lenses are degraded. The gap examples in a depth map T specified in the first exemplary use can also arise if an impairment D is present on both camera lenses simultaneously. Depending on the position of the respective impairments D on the camera lenses, a stereo matching can take place in some circumstances, such that no gaps occur in the depth map T. This abnormality can, however, be recorded by means of the plausibility check described using the object recognition and the comparison with the object information stored in the digital map and can thus be recognized as an impairment D.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the FIGURES enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9. (canceled)

10. A method for recognizing impairments in an optical path of a stereo camera, the method comprising:
generating a depth map of a recorded environment using image data recorded by the stereo camera;
checking whether gaps without depth values are present in the depth map; and
determining that impairments are present in the optical path of the stereo camera if gaps are present in the depth map.

11. The method of claim 10, further comprising:
recognizing objects in the depth map; and
performing a plausibility check of depth information of the depth map by comparing the recognized objects with object information stored in a digital map.

12. The method of claim 11, wherein implausible depth information is interpreted as confirmation of an impairment in the optical path of the stereo camera.

13. The method of claim 11, wherein implausible depth information is interpreted as confirmation of an impairment in the optical path of the stereo camera if there are no gaps present in the depth map.

14. The method of claim 10, wherein the image data is recorded by the stereo camera while the stereo camera is at a standstill relative to the recorded environment.

15. The method of claim 11, wherein the recognizing of objects involves lane recognition, number plate recognition, or recognition of mobile and/or immobile environment objects.

16. A device for recognizing impairments in an optical path of a stereo camera, the device comprising:
a processing device configured to
generate a depth map of a recorded environment using image data recorded by the stereo camera;
check whether gaps without depth values are present in the depth map; and
determine that impairments are present in the optical path of the stereo camera if gaps are present in the depth map.

17. A vehicle, comprising:
a device for recognizing impairments in an optical path of a stereo camera, the device comprising
a processing device configured to
generate a depth map of a recorded environment using image data recorded by the stereo camera;
check whether gaps without depth values are present in the depth map; and
determine that impairments are present in the optical path of the stereo camera if gaps are present in the depth map.

18. The vehicle of claim 17, wherein the vehicle is configured to be autonomously driven.
